(19) United States
(12) Patent Application Publication
(10) Pub. No.: US 2026/0189111 A1
(43) Pub. Date: Jul. 2, 2026

(54) Insulating Disc and Method for Insulating the Brush Area of an Electric Machine

(71) Applicant: Bayerische Motoren Werke Aktiengesellschaft, Muenchen (DE)

(72) Inventors: Philip MOERTH, Muenchen (DE); Christine SCHMIDMAYER, Erding (DE)

(21) Appl. No.: 19/129,335

(22) PCT Filed: Nov. 7, 2023
(86) PCT No.: PCT/EP2023/080983

§ 371 Date: May 13, 2025

(30) Foreign Application Priority Data
Dec. 22, 2022 (DE) 10 2022 132 274.2

(51) Int. Cl. H02K 13/00; H02K 15/10

(52) U.S. Cl. CPC H02K 13/006; H02K 15/10

(57) ABSTRACT

An insulating disc for an electric machine, which has a slip-ring module, which is arranged on the rotor shaft of the rotor of the electric machine, and a brush module, which is arranged on the housing of the electric machine. The insulating disc comprises an insulating face which is designed to spatially shield the brush area, which is formed by the slip-ring module and by the brush module, from the housing. The insulating disc also comprises one or more fastening elements which make it possible to fasten the insulating face to the brush module and/or to the housing of the electric machine.

### BACKGROUND AND SUMMARY

This disclosure relates to an electric machine, for instance an electrically excited synchronous machine. In particular, the disclosure relates to an insulation disk and to a method for electrically insulating the brush space of the electrically excited rotor of an electric machine.

An at least partially electrically driven vehicle comprises an electric machine for driving the vehicle. The electric machine comprises a stator which encloses a rotor of the electric machine. The rotor shaft for an electrically excited rotor can have a slip ring module with electric (module) lines, wherein the electric lines are configured to connect slip rings in an electrically conducting manner to the windings of the rotor. Furthermore, the rotor comprises a brush module with brushes for making electric contact with the corresponding slip rings of the slip ring module.

During operation of the electric machine, an insulation fault within the electric machine and, as a consequence of this, a failure of the electric machine can occur. The present document is concerned with the technical object of avoiding insulation faults of an electrically excited electric machine in an efficient and reliable way.

In accordance with one aspect, an insulation disk for an (electrically excited) electric machine is described. The electric machine comprises a slip ring module (for example, with two slip rings), arranged on (in particular, fastened to) the rotor shaft of the rotor of the electric machine. Furthermore, the electric machine comprises a brush module, arranged on (in particular, fastened to) the housing of the electric machine. The brush module can have one or more brushes for each slip ring of the slip ring module for making electric contact with the respective slip ring. The slip ring module can be arranged in a (circular) cutout of the brush module. The cutout of the brush module can enclose and/or form a brush space. The brush space can be formed, in particular, by the slip ring module and by the brush module. One or more electrically conducting (metallic and/or hair-like) chips which can lead to an insulation fault of the electric machine can be arranged in the brush space.

The insulation disk comprises a (preferably circular) insulation surface which is configured to shield the brush space spatially from the housing. The brush module can have at least one end surface (which runs perpendicularly with respect to the rotor shaft of the electric machine). The brush module can have, in particular, an end surface which faces or is averted from an end-side housing wall of the housing of the electric machine (wherein the housing wall is arranged perpendicularly with respect to the rotor shaft). The brush module can possibly be fastened on this end-side housing wall to the housing of the electric machine (for example, by one or more fastening bolts). The insulation surface can be configured to cover the end surface of the brush module partially or completely.

The insulation disk, in particular the insulation surface, can have a central opening for receiving the rotor shaft and/or the slip ring module. The insulation disk can thus be used in a particularly precise way to cover an end surface of the brush module (wherein the end surface is arranged perpendicularly with respect to the rotor shaft).

The insulation disk and/or the insulation surface can consist of an electrically insulating material, in particular a plastic, for instance a fiber-reinforced plastic. The insulation surface can be formed, for example, by a (possibly fiber-reinforced) film.

Furthermore, the insulation disk comprises one or more fastening elements which are configured to fasten, in particular to clip and/or to clamp and/or to screw, the insulation surface to the brush module and/or to the housing, in particular to the end-side housing wall of the housing, of the electric machine.

The insulation disk described in this document enables particularly efficient and reliable avoidance of insulation faults of an electric machine on account of electrically conducting chips in the brush space of the electric machine.

As has already been stated further above, the brush module can be fastened to the end-side housing wall of the housing of the electric machine by two or more (in particular, by precisely three) bolts. The insulation surface can have two or more cutouts on the (possibly circular) edge of the insulation surface for the corresponding two or more bolts. The profile of the individual cutouts can be adapted to the (possibly circular) profile of the respective bolt. As a result of the provision of cutouts for the fastening bolts, the brush space can be shielded or covered in a particularly reliable way.

The two or more cutouts can each be configured as a fastening element, in particular in such a way that the insulation disk can be clipped and/or clamped and/or screwed via the two or more cutouts to the corresponding two or more bolts.

Furthermore, the insulation disk can have, at the two or more cutouts, in each case one mechanical reinforcement which extends, in particular perpendicularly, away from the insulation surface. Here, the reinforcements can each be adapted to the profile of the corresponding bolt. The reinforcement can have, for example, the shape of a section of a tube. The reinforcement can extend, for example, over a length along the rotor shaft of from 0.2 cm to 5 cm or of up to 1 cm.

Furthermore, the cutout and the corresponding reinforcement can each be configured to partially enclose the corresponding bolt, in particular to enclose more than 50% of the circumference of the bolt. For example, the mechanical reinforcement can have a length in the circumferential direction of the circumference of the bolt of between 50% and 70% of the overall circumference of the bolt. Particularly stable and efficient fixing of the insulation disk to the electric machine can thus be brought about.

The insulation surface of the insulation disk can have two or more (in particular, precisely three) bores which are each configured to receive a fastening pin (for example, in each case one fir tree clip or in each case one screwing element (for instance, in each case one screw)) for fastening the insulation disk to the brush module and/or to the housing of the electric machine. The brush module and/or the housing of the electric machine can have two or more corresponding bores (which are arranged in each case in a flush manner). Particularly efficient and stable fixing of the insulation disk to the electric machine, in particular to the brush module, can thus be brought about.

For improved fixing of the individual fastening pins (in particular, of the individual clips or screwing elements), the bores of the brush module and/or the housing of the electric machine can each be provided with a thread. As an alternative, through holes which are molded on a carrier (for example, on a plastic body) of the brush module can be positioned in such a way that a step which serves as a latch for the clips is produced in a two-part mold.

The bores of the brush module and/or the housing of the electric machine can therefore each have a varying diameter along the rotor shaft (for example, in the form of a thread and/or in the form of at least one step). Particularly reliable fixing of a fastening pin (in particular of a (fir tree) clip) within the corresponding bore can be brought about by the varying diameter. In particular, latching of the fastening pin can be brought about by the provision of a step within the bore.

In accordance with a further aspect, a brush module for an electric machine is described. The brush module can have one or more (carbon) brushes for each of the slip rings of the electric machine. The brush module can be configured to be fastened to the housing, in particular to the end-side housing wall of the housing, of the electric machine. The end-side housing wall can be arranged perpendicularly with respect to the rotor shaft of the electric machine.

The brush module can have at least one of the insulation disks described in this document, which insulation disk is configured to shield and/or to disconnect the brush space of the brush module spatially from the housing, in particular from the end-side housing wall of the housing, of the electric machine. The insulation disk can be configured to cover the brush space on an end surface of the brush module.

The insulation disk can be fastened to two or more fastening bolts of the brush module, wherein the two or more fastening bolts are provided for fastening the brush module to the housing, in particular to the end-side housing wall of the housing, of the electric machine.

As an alternative or in addition, the insulation surface of the insulation disk can have two or more bores. Furthermore, the brush module can have a carrier (for example, a base plate and/or a plastic body) with two or more bores which are arranged in a flush manner with respect to the corresponding two or more bores of the insulation surface of the insulation disk. The carrier can be configured to support the one or more brushes of the brush module.

Furthermore, the brush module can have two or more fastening pins which are arranged in the corresponding two or more bores of the insulation surface of the insulation disk and of the carrier of the brush module, in order to fasten the insulation surface to the carrier of the brush module. Here, the two or more fastening pins can each be configured as a fir tree clip. Particularly efficient and stable fastening of the insulation disk can thus be brought about.

The two or more bores in the carrier of the brush module can each have a diameter which changes along the respective bore. Here, the change in the diameter can be configured, in particular, in such a way that a step for latching the corresponding fastening pin is formed within the respective bore. Particularly efficient and stable fastening of the insulation disk can thus be brought about.

As has already been stated further above, the brush module can be configured to be fastened to the end-side housing wall of the housing of the electric machine. The brush module can have a first insulation disk (which is configured as described in this document) which covers that end surface of the brush module which faces the housing wall. Furthermore, the brush module can have a second insulation disk (which is configured as described in this document) which covers that end surface of the brush module which is averted from the housing wall. The brush space can thus be enclosed between the two insulation disks in a particularly reliable way, as a result of which particularly reliable protection against insulation faults is brought about.

In accordance with a further aspect, an electric machine, in particular an (electrically excited) synchronous machine, is described. The electric machine typically comprises a rotor with a rotor shaft, on which one or more slip rings are arranged, and a brush module for making electric contact with the one or more slip rings. The brush module can be configured as described in this document. The electric machine can comprise at least one insulation disk which is configured to shield and/or to disconnect the brush space of the brush module spatially from the housing of the electric machine. The insulation disk can be fastened to the housing of the electric machine and/or to the brush module.

In accordance with a further aspect, a (road) motor vehicle (in particular, a passenger motor car or a truck or a bus or a motorcycle) is described which comprises the electric machine, described in this document, for driving the vehicle.

In accordance with a further aspect, a method for electrically insulating the brush space of an electric machine from the housing of the electric machine is described. The brush space can be formed by a slip ring module, arranged on the rotor shaft of the rotor of the electric machine, and by a brush module, arranged on the housing of the electric machine. The method comprises arranging an insulation surface (in particular, an insulation disk with an insulation surface) between the housing of the electric machine and the brush module, with the result that the insulation surface shields and/or disconnects the brush space spatially from the housing. The insulation surface can be arranged or run in (precisely) one plane, perpendicularly with respect to the rotor shaft. The insulation surface can have the shape of a planar disk or plate (possibly with a (circularly) round periphery).

It is to be noted that the apparatuses, methods and systems described in this document can be used both on their own and in combination with other apparatuses, methods and systems described in this document. Furthermore, any aspects of the apparatuses, methods and systems described in this document can be combined with one another in a wide variety of ways. In particular, the features of the claims can be combined with one another in a wide variety of ways. Furthermore, features placed between parentheses are to be understood to be optional features.

### BRIEF DESCRIPTION OF THE DRAWINGS

In the further text, the disclosure will be described in greater detail on the basis of exemplary embodiments.

FIG. 1a shows an exemplary electric machine;

FIG. 1b shows a perspective view of an exemplary rotor body;

FIG. 2a shows a perspective view of an exemplary rotor shaft with a slip ring module;

FIG. 2b shows a diagrammatic drawing of a brush module;

FIG. 3a shows a diagrammatic drawing of an electric machine with an insulation disk for insulating the brush space of the electric machine;

FIG. 3b shows a perspective view of an insulation disk;

FIG. 3c shows a perspective view of a brush module with an insulation disk;

FIG. 4a shows a perspective view of a brush module which is covered with an insulation disk on each of the two end surfaces;

FIG. 4b shows an exemplary clip for fastening an insulation disk to a brush module; and,

FIG. 5 shows a flow chart of an exemplary method for insulating the brush space of an electrically excited electric machine.

### DETAILED DESCRIPTION OF THE DRAWINGS

As stated at the outset, the present document is concerned with the efficient and reliable (electric) insulation of the brush space of an electric machine. In this context, Fig. la shows an exemplary electric machine 100 in a view perpendicularly onto the shaft 101 of the electric machine 100. The shaft 101 of the electric machine 100 can correspond to the longitudinal axis of the stator 110 and/or the rotational axis or the rotor shaft of the rotor 120 of the electric machine 100. Furthermore, the shaft 101 can run along the z-axis of the Cartesian coordinate system which is shown.

The electric machine 100 comprises a stator 110 with a plurality of stator windings 111 which are arranged at different angular positions around the rotational axis of the rotor 120 and which are configured to generate an electromagnetic rotary field. The stator 110 is surrounded by a housing 135 of the electric machine 100.

Furthermore, the electric machine 100 comprises the rotor 120 which is driven by the rotary field which is brought about by the stator 110. The rotor 120 is connected fixedly to the shaft 101 which is driven by the electric machine 100 (which can be connected to the rotor shaft of the rotor 120 or which corresponds to the rotor shaft of the rotor 120). The rotor 120 comprises a rotor body 122.

The rotor 120 of an electric machine 100 can have, as rotor body 122, an iron laminated core (for example, composed of rotor laminations which are insulated with respect to one another). In a corresponding way, the stator 110 can also be composed of individual stator laminations (for example, iron laminations) (which are insulated with respect to one another).

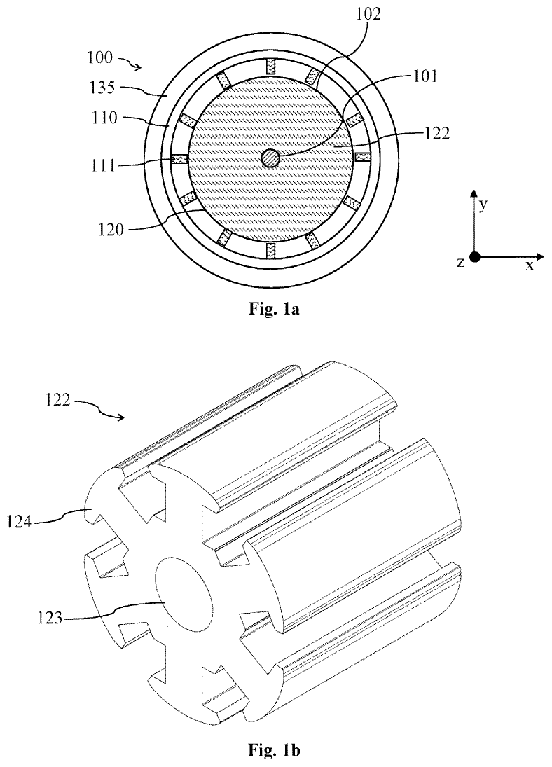

FIG. 1b shows an exemplary rotor body 122 of a rotor 120 in a perspective view. The rotor body 122 extends along the rotational axis of the rotor 120 from a first end surface as far as an opposite second end surface. Here, the rotor body 122 in the example which is shown has different magnetic salient poles 124 which are arranged around the rotational axis of the rotor 120. The salient poles 124 can be arranged distributed uniformly around the rotational axis. A coil (that is to say, in each case one winding) can be arranged around each of the individual salient poles 124, by which coil a magnetic field is generated. The individual salient poles 124 can therefore form magnetic poles of the rotor 120.

The rotor body 122 has a central cutout 123, in particular a bore, into which a rotor shaft of the rotor 120 can be introduced. The rotor shaft can be mounted rotatably on the end surfaces of the rotor body 122 via respective bearing surfaces, in order to enable a rotation of the rotor 120.

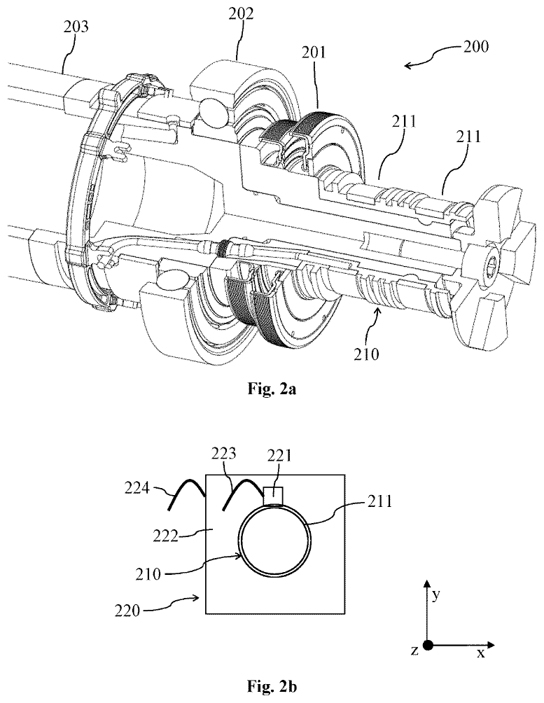

FIG. 2a shows a perspective view of an exemplary rotor shaft 200 of the rotor 120 which has a slip ring module 210 with a plurality of (in particular, with two) slip rings 211. The rotor shaft 200 has a rotor body region 203 (with a circular-cylindrical shell surface), around which the rotor body 122 of the rotor 120 is arranged. Furthermore, the rotor shaft 200 has at least one bearing 202 for mounting the rotor shaft 200 and the rotor 120. Furthermore, the rotor shaft 200 can have one or more sealing rings 201 for sealing the rotor 120 (in order to avoid coolant for cooling the rotor 120 escaping from the rotor 120).

The slip ring module 210 is arranged at one end of the rotor shaft 200, and is therefore typically accessible from the outside. Starting from the individual slip rings 211, electric lines can be routed through below the bearing 202 to the rotor body 122, in order to make contact with the windings of the rotor 120 in an electrically conducting manner. The slip ring module 210 can have a first slip ring 211 for a first electric pole (for example, for a positive pole) and a second slip ring 211 for a second electric pole (for example, for a negative pole).

FIG. 2b shows a brush module 220 which has one or more brushes 221, in order to make contact in an electrically conducting manner with the corresponding one or more slip rings 211 of the slip ring module 110. FIG. 2b shows the brush module 220 in a view perpendicularly onto the rotor shaft 200. The brush module 220 can have, in particular, one or more first brushes 221 (for example, three first brushes) for making electric contact with the first slip ring 211, and one or more second brushes 221 (for example, three second brushes) for making electric contact with the second slip ring 211. In particular, three brushes 221 which are arranged uniformly around the rotational axis of the rotor 120 (in each case with an angular spacing of 120°) can be provided for each slip ring 211.

The brushes 221 can be fastened to an electrically conducting base plate 222. Furthermore, the individual brushes 221 can be connected via in each case one electrically conducting braid 223 to the base plate 222. The base plate 222 can in turn be connected via an electric line 224 to a power supply. The brush module 220 can have, in particular, a first base plate 222 with the one or more first brushes 221 and a second base plate 222 (electrically insulated from the first base plate 222) with the one or more second brushes 221.

During the operation of the electric machine 100 and/or within the context of the production of the slip ring module 210, a hair-shaped chip can form on one of the slip rings 211 of the slip ring module 210. Electric contact of the slip ring 211 with the housing 135 of the electric machine 100 and, as a consequence of this, an insulation fault can be brought about by a hair-shaped chip of this type. In this document, an insulation disk is described which can be arranged, in particular, between the housing 135 and the brush space on the brush module 220 of the electric machine 100, in order to avoid an insulation fault of this type in an efficient and reliable way.

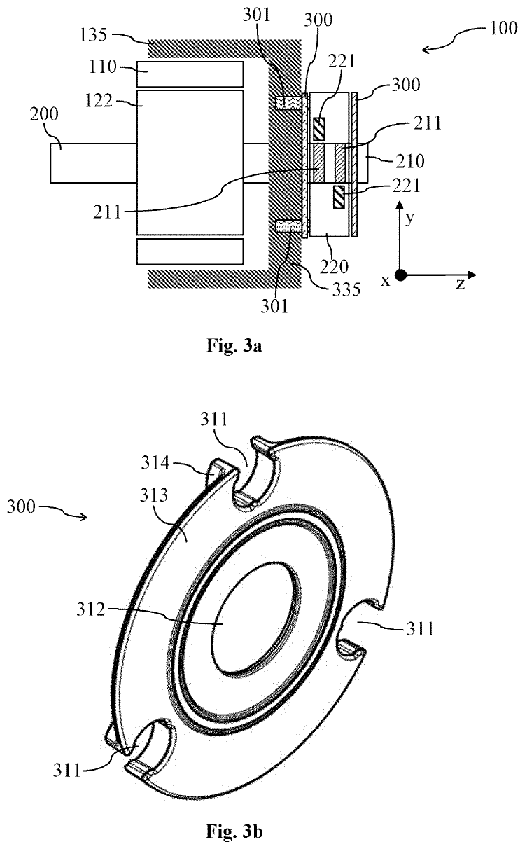

FIG. 3a shows an electric machine 100 in a side view, in which the rotor shaft 200 runs horizontally within the plane of the drawing. The housing 135 of the electric machine 100 has an end-side housing wall 335 (which is arranged perpendicularly with respect to the rotor shaft 200) on the end surface which faces the slip ring module 210 and the brush module 220. The brush module 220 can be fastened to the end-side housing wall 335 via two or more (in particular, via three) bolts 301. The brush space 310 of the electric machine 100 corresponds to the region on which the slip rings 211 of the slip ring module 210 and the brushes 221 of the brush module 220 are arranged.

The machine 100 which is shown in FIG. 3a has an insulation disk 300 which is arranged between the end-side housing wall 335 and the brush space 310. The insulation disk 300 can be fastened to, for example plugged onto, the bolt 301, via which the brush module 220 is fastened to the end-side housing wall 335.

FIG. 3b shows a perspective view of an exemplary insulation disk 300. The insulation disk 300 has an insulation surface 313 which is configured to cover a (mechanically rigid) end surface (in particular, the end surface which faces the housing wall 335) of the brush space 310, in order to shield the brush space 310 spatially and/or electrically from the housing wall 335. The insulation surface 313 consists of an electrically insulating material, for example of a plastic. Furthermore, the insulation surface 313 preferably consists of a solid, non-elastic material.

The insulation disk 300 has a central opening 312 (in particular, a bore) for receiving the rotor shaft 200 and/or the slip ring module 210 which is arranged on the rotor shaft 200. The diameter of the central opening 312 corresponds substantially to the diameter of the rotor shaft 200 or the slip ring module 210, in such a way that the rotor shaft 200 can rotate without making contact with the insulation disk 300.

In the example which is shown in FIG. 3b, the insulation disk 300 has two or more (in particular, three) cutouts 311 on the (circular) edge of the insulation surface 313, wherein the individual cutouts 311 are each configured in such a way that the insulation disk 300 can be fastened to, in particular clamped on, the corresponding fastening bolts 301 of the brush module 220 using the individual cutouts 311. The insulation disk 300 can thus be integrated into the electric machine 100 in an efficient and stable way.

The insulation disk 300 can have a mechanical reinforcement 314 (which, for example starting from the insulation surface 313, extends in the direction of the rotor shaft 200, for example over 0.5 cm or more) on each of the individual cutouts 311. The fixing of the insulation disk 300 on the fastening bolts 301 can thus be improved further.

FIG. 3c shows an exemplary perspective view of a brush module 220, on which an insulation disk 300 is arranged. Bores 331 (which are possibly mechanically reinforced) for the corresponding bolts 301 can be arranged on one or on the two base plates 222 of the brush module 220.

As shown by way of example in FIG. 3a, the electric machine 100 can have a further insulation disk 300 on the end surface, averted from the end-side housing wall 335, of the brush space 310 or the brush module 220. The brush space 310 can thus be shielded and/or covered in a particularly reliable way, in order to avoid an insulation fault.

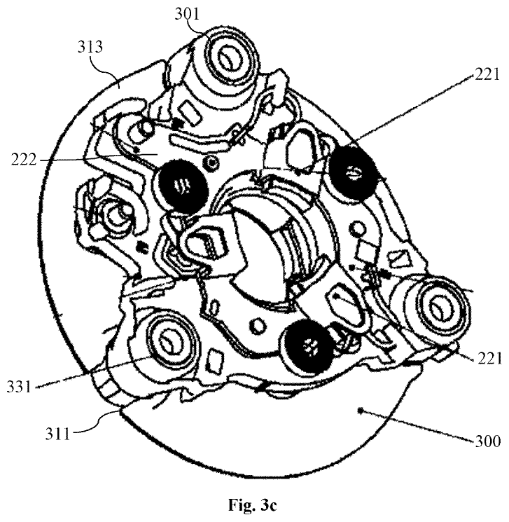

FIG. 4a shows an exemplary brush module 220 which has an insulation disk 300 at each of the two opposite end surfaces. The individual insulation disks 300 each have cutouts 311 for the fastening bolts 301 of the brush module 220. In the example which is shown in FIG. 4a, however, fastening of the respective insulation disk 300 to the brush module 220 possibly does not take place via these cutouts 311.

The insulation disks 300 which are shown in FIG. 4a each have bores 402 (in particular, three bores 402) which are arranged in a flush manner with respect to corresponding bores 404 in at least one or in the two base plates 222 of the brush module 220. An (electrically non-conducting) fastening pin 403 can be guided through each of the bores 402, 404, in order to fasten the respective insulation disk 300 to the brush module 220. Particularly stable fastening of the one or more insulation disks 300 to the brush module 220 can thus be brought about.

FIG. 4b shows an exemplary fastening pin 403 which is introduced through a bore 402 in the insulation surface 313 of an insulation disk 300 and into a corresponding bore 404 in a base plate 222 of the brush module 220. The fastening pin 403 can be configured, for example, as a fir tree clip with a correspondingly shaped shell surface 413. Particularly efficient fastening of an insulation disk 300 to the brush module 220 can thus be brought about.

As stated at the outset, the production of an (electrically conducting) angel hair or chip can occur during the processing of the slip ring module 210. The angel hair can consist, for example, of bronze or copper. The angel hair can possibly lead to an insulation fault between the slip ring module 210 and the housing 135, 335 of the electric machine 100 during operation of the electric machine 100.

In this document, an insulation disk 300 is described which consists, for example, of plastic and/or a non-conducting material. The insulation disk 300 can be clipped onto the brush holder module or brush module 220. The installation space between the slip ring module 210 and the housing 135, 335 is disconnected spatially from one another by the insulation disk 300. As a consequence of this, an electrically conducting connection between the slip ring module 210 and the housing 135, 335 cannot be brought about by an electrically conducting chip.

Therefore, a measure for electrically insulating against (copper) chips in the brush space 310 of the electric machine 100 is described. An operational interruption of the electric machine 100 on account of an insulation fault can thus be avoided reliably.

For insulation purposes, one or two thin insulation layers (that is to say, insulation disks 300) can be fastened to the main body 222 of the voltage-conducting component (in particular, of the brush module 220), in order to bring about a spatial disconnection. For example, one or two fiber-reinforced stamped films (as insulation disks 300) can be fixed by way of rivets 403 on both sides of the component to be insulated (in particular, the brush module 220).

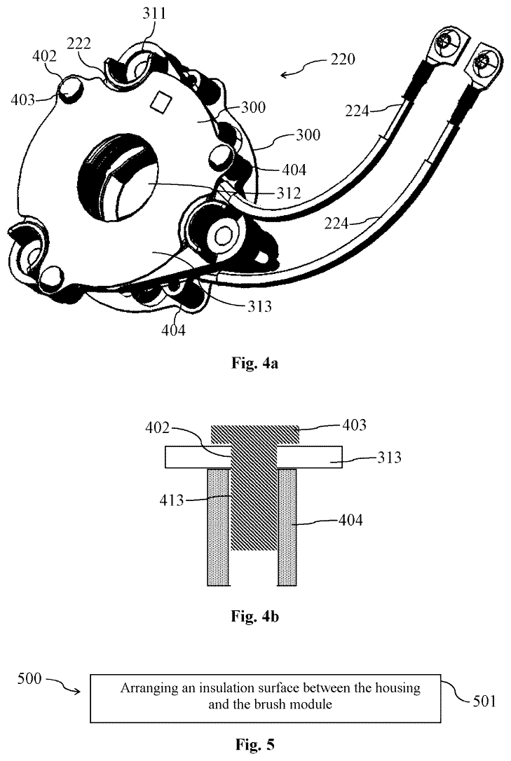

FIG. 5 shows a flow chart of an exemplary method 500 for electrically insulating the brush space 310 of an (electrically excited) electric machine 100 from the housing 135, 335, in particular from a housing wall 335 of the housing 135, of the electric machine 100. The brush space 310 is formed by a slip ring module 210, arranged on the rotor shaft 200 of the rotor 120 of the electric machine 100, and by a brush module 220, arranged on the housing 135, 335, in particular on the housing wall 335, of the electric machine 100. The brush space 310 can comprise, for example, the space between the individual slip rings 211 and the individual brushes 221 of the slip ring module 210 and the brush module 220. Furthermore, the brush space 310 can be limited to the space which is enclosed by the brushes 221 of the brush module 220.

The method 500 comprises arranging 501 an insulation surface 313, in particular an insulation disk 300, between the housing 135, 335 of the electric machine 100 and the brush module 220, with the result that the insulation surface 313 shields the brush space 310 spatially from the housing 135, 335. The insulation surface 313 can be arranged, in particular, on an end surface of the brush module 220 between the housing wall 335 and the brush module 220. The insulation surface 313 can be fastened to, in particular clipped onto, the housing wall 335 and/or the brush module 220.

By way of the measures which are described in this document, the brush space 310 of an electric machine 100 can be shielded in a particularly efficient and reliable way from the surrounding area of the brush space 310, in particular from the housing 135 of the electric machine 100. Insulation faults (for example, on account of an angel hair on a slip ring 211) can thus be avoided reliably.

The present disclosure is not restricted to the exemplary embodiments which are shown. It is to be noted, in particular, that the description and the figures are intended to merely describe by way of example the principle of the proposed apparatuses, methods and systems.

1-16. (canceled)

17. An insulation disk for an electric machine, comprising:
a slip ring module, arranged on a rotor shaft of a rotor of the electric machine, and a brush module, arranged on a housing of the electric machine;
wherein the insulation disk comprises:
an insulation surface which is configured to shield a brush space, formed by the slip ring module and by the brush module, spatially from the housing; and,
one or more fastening elements which are configured to fasten the insulation surface to the brush module and/or to the housing of the electric machine.

18. The insulation disk according to claim 17, wherein:
the brush module has an end surface which faces or is averted from an end-side housing wall of the housing of the electric machine; and
the insulation surface is configured to cover the end surface of the brush module.

19. The insulation disk according to claim 17, wherein the insulation disk has a central opening for receiving the rotor shaft and/or the slip ring module.

20. The insulation disk according to claim 17, wherein:
the brush module is fastened by two or more bolts to an end-side housing wall of the housing of the electric machine; and
the insulation surface has two or more cutouts on a circular edge of the insulation surface for the corresponding two or more bolts.

21. The insulation disk according to claim 20, wherein the two or more cutouts are each configured as a fastening element, in such a way that the insulation disk can be clipped and/or clamped or screwed via the two or more cutouts to the corresponding two or more bolts.

22. The insulation disk according to claim 21, wherein:
the insulation disk, on the two or more cutouts, in each case one mechanical reinforcement which extends perpendicularly away from the insulation surface; and
a cutout and the corresponding reinforcement are configured to partially enclose a corresponding bolt to enclose more than 50% of a circumference of the bolt.

23. The insulation disk according claim 17, wherein the insulation surface has two or more bores which are each configured to receive a fastening pin for fastening the insulation disk to the brush module and/or to the housing of the electric machine.

24. The insulation disk according to claim 17, wherein the one or more fastening elements are configured to clip and/or clamp or screw the insulation surface to the brush module and/or to the housing of the electric machine.

25. The insulation disk according to claim 17, wherein the insulation disk and/or the insulation surface consist/consists of an electrically insulating material.

26. A brush module for an electric machine, wherein:
the brush module is configured to be fastened to an end-side wall of a housing of the electric machine; and
the brush module comprises at least one insulation disk according to claim 17 which is configured to shield a brush space of the brush module spatially from the housing, from the end-side housing wall of the housing, of the electric machine.

27. The brush module according to claim 26, wherein:
the insulation surface of the insulation disk has two or more bores;
the brush module has a carrier with two or more bores which are arranged in a flush manner with respect to the corresponding two or more bores of the insulation surface of the insulation disk; and
the brush module has two or more fastening pins which are arranged in the corresponding two or more bores of the insulation surface of the insulation disk and the carrier of the brush module, in order to fasten the insulation surface to the carrier of the brush module.

28. The brush module according to claim 27, wherein the two or more fastening pins are each configured as a fir tree clip or as a screwing element.

29. The brush module according to claim 26, wherein the two or more bores in the carrier of the brush module have a diameter which changes along the respective bore, in such a way that a step for latching the corresponding fastening pin is formed within the respective bore.

30. The brush module according to claim 26, wherein:
the brush module is configured to be fastened to the end-side housing wall of the housing of the electric machine;
the brush module has a first insulation disk which covers an end surface, facing the housing wall, of the brush module; and
the brush module has a second insulation disk which covers an end surface, averted from the housing wall, of the brush module.

31. An electric machine, comprising:
a rotor with a rotor shaft, on which a slip ring module with one or more slip rings is arranged; and
a brush module according to claim 26 for making electrical contact with the one or more slip rings.

32. A method for electrically insulating a brush space of an electric machine from a housing of the electric machine, wherein the brush space is formed by a slip ring module, arranged on a rotor shaft of a rotor of the electric machine, and a brush module, arranged on a housing of the electric machine, the method comprising:
arranging an insulation surface between the housing of the electric machine and the brush module, with the result that the insulation surface shields the brush space spatially from the housing.
